(19) United States
(12) Patent Application Publication
(10) Pub. No.: US 2006/0009238 A1
(43) Pub. Date: Jan. 12, 2006

(54) Personal communication devices

(76) Inventors: Bart Stanco, Fairfield, CT (US); Merzhad Mahdavi, Houston, TX (US)

Correspondence Address: BACHMAN & LAPOINTE, P.C., 900 CHAPEL STREET, SUITE 1201, NEW HAVEN, CT, 06510, US

(21) Appl. No.: 10/860,690

(22) Filed: Jun. 3, 2004

Related U.S. Application Data
(60) Provisional application No. 60/476,262, filed on Jun. 3, 2003.

(51) Int. Cl. H04Q 7/20

(52) U.S. Cl. 455/456.2; 455/456.1

(57) ABSTRACT

A secure communication and locating system includes a mobile communication device adapted to communicate with a global positioning system and a cell triangulation system, a monitoring system communicated with the mobile communication device and adapted for: determining authorization of a user, determining location of the mobile communication device and providing location to a user determined to be authorized.

### CROSS REFERENCE TO PROVISIONAL APPLICATION

This application claims the benefit of co-pending provisional application Ser. No. 60/476,262, filed Jun. 3, 2003.

### BACKGROUND OF THE INVENTION

This invention relates to systems, methods and processes for allowing members of a group, for example, family members, friends, and other groups of individuals, to instantly speak with and locate one another.

Global Positioning Satellite (GPS) technology and services are available today for a variety of applications. Relevant to this invention are the devices that provide location services with the use of GPS. Applied Digital Solutions offers “Digital Angel”, a cigarette pack size unit that clips to the belt and provides GPS location services. Another company, Wherify Wireless, is marketing a GPS child locator in the form of a wrist watch. The watch includes a 911 call button. Parents can pinpoint location of a child via a web site or a call to a special hot line.

The object of the invention is to enhance these technologies and provide a versatile system for communicating individuals for enhanced safety, peace of mind, convenience and the like.

### SUMMARY OF THE INVENTION

In accordance with the present invention, a method and processes are provided which combine GPS and Direct Talk (DT) or walkie-talkie-like communication providing both location and voice services, in a secure and convenient manner.

Combination of cellular triangulation and GPS for location services enables several new capabilities. With cell triangulation algorithms, location services can be provided within 100 meters. Cell triangulation provides “indoor” coverage while GPS does not, so with cell triangulation as the default mode, less battery usage is required and therefore smaller devices are possible to integrate location services and direct talk features. GPS provides a more exact location for “outdoor” locations and can be activated “on demand” for more optimized use of power at the same time, thereby enabling providing coverage indoors via cellular triangulation and outdoors via cellular triangulation or GPS depending upon accuracy needs and available battery power.

Authentication is a critical feature of the present invention, and users of the service must be authenticated for safety reasons. Strong authentication schemes are devised to identify the users. Voice, other biometrics (e.g., finger print), smart cards and the like are implemented as part of this invention. Un-authenticated voice calls and instructions are incorporated into the system, which is preferably adapted to drop unauthorized communications before reaching the receiver and/or to take other appropriate action.

This invention allows the optimized use of many devices for different purposes. Devices integrate direct talk, GPS, and cell location services. These devices can be simple and lightweight. For example, a wristwatch or a pendant can be provided having navigating (thumb) button, yes/no buttons, and an emergency button. To download contacts, other information, and synchronization, these devices can be equipped with a cradle with connection to processors such as PCs and PDAs, cell phones and other smart devices.

Many applications are possible for integration with the above services, including:

sending street address directly to the phone display “on demand” or as per configured schemes;

access to emergency and medical databases by 911 services and health care providers; and

mapping of hot zones such that, for example, as a user moves into or outside of a hot zone, alert(s) are sent to the other device(s).

Combining the devices and applications are a set of processes and procedures that allow users to take full advantage of the services conveniently. For example, call centers are set up to connect users (with proper authentication) if other forms of direct connections fail. Call centers can also feed medical and other information to healthcare providers.

A particular embodiment of the invention includes a secure communication and locating system, which comprises a mobile communication device adapted to communicate with a global positioning system and a cell triangulation system; a monitoring system communicated with the mobile communication device and adapted for: determining authorization of a user; determining location of the mobile communication device; and providing location to a user determined to be authorized.

A unique business process is provided by which individuals, for example family members and/or friends, stay connected instantly and securely anytime and anywhere, with many value added services.

### BRIEF DESCRIPTION OF THE DRAWINGS

A detailed description of preferred embodiments of the present invention follows, with reference to the attached drawings, wherein:

FIG. 1 illustrates the operator interface portion of a device in accordance with the present invention;

FIG. 2 illustrates a web site page utilizing a function of the system of the present invention;

FIG. 3 illustrates a fire walled operator network in accordance with a system of the present invention; and

FIG. 4 further illustrates a fire walled operator network in accordance with the present invention.

### DETAILED DESCRIPTION

The invention relates to a system including methods and processes for individuals such as family members, friends and the like to instantly speak with and locate one another in a secure and highly functional manner.

According to the invention, a communication device is provided, as well as a system incorporating same, whereby authenticated users have access to communication and location services, advantageously allowing them to locate and/or communicate with a subject user carrying the device. The device is simple to use and can be tailored to a wide variety of different consumers or other users.

Integral to the system are portable devices which can be incorporated into pendants, wristwatch devices and the like, and an operator network, each of which is further described below.

FIG. 1 shows the interface portion of a device 10 in accordance with the invention which, in this case, is a device which could readily be adapted for wearing as a pendant, or on a band as a wristwatch, or in other ways.

Device 10 includes controls which are desirably simple, typically including a display 12, and a plurality of buttons generally indicated at 14 including navigating buttons, a select button, on-off buttons and the like. In addition, it is preferred that device 10 include a button for the “direct talk” (DT), push to talk (PTT) or walkie-talkie-like feature of the device, and a further button, for example a panic button, which is intended for use in an emergency and which initiates an emergency protocol.

PTT capability can be adapted to be integrated into public switch telephone network, or voice over internet protocol telephone network, or the like. This would involve adapting the system to create a ringing alert and answering detection and a control of the PTT circuits. Device 10 is preferably adapted to connect with or fit on a cradle, not shown in FIG. 1, for downloading applications, DT numbers and other data with synchronization capability. In this manner, or in other ways, device 10 can be provided with programming as desired.

The embodiment illustrated in FIG. 1 is most preferably adapted for use as a pendant, in a wristwatch version of this device, similar buttons are adapted and incorporated along with digital watch capability, and a suitable battery can be an integral part of the wristband.

Device 10 is advantageously adapted to communicate with location sensing or tracking services such as GPS, cell triangulation, or both, so that location of device 10 can be conveyed to an authenticated user of the network.

The electronics and type of programming for providing a device 10 in accordance with the present invention are well within the level of skill of a person of ordinary skill in the art. Nevertheless, these features will be further discussed below.

Although FIG. 1 shows device 10 as a pendant, it should be noted that device 10 could also be provided in the form of a locket, for example with photos and pin on structures, or as a beeper, or as a pet track collar, or as a device incorporated into a camera, as several example.

The system components and functionality can also be repackaged into other product specifically for different situations and/or types of individual. For example, the device can be provided with or without cell phone capabilities, and a non-cell phone capable device may be preferable for children, for example of ages 5-12 years.

Other groups toward which devices can be specifically repackaged include adult females, elderly, impaired or infirm individuals, teenagers, sports enthusiasts, travelers and the like, to provide non-limiting examples.

In addition, the device can further be repackaged for hidden applications, for example by being incorporated into shoes, car seats, and other locations where the device is likely to be difficult to detect, for example by a hostile individual, kidnapper or the like.

In accordance with a further aspect of the invention, the device of the present invention can be incorporated into processors such as computers, especially PC's and the like, to enhance functionality of same, and can be adapted for use with PCMIA, Compaq Flash and other software packages for enhancing versatility. Features which can advantageously be incorporated into the present invention are further described as set forth below.

The device of the present invention can advantageously be pinged, such that the ping toggles or latches the system so as to activate various features such as the direct connect or walkie-talkie feature, camera (shown schematically in FIG. 1 at 16), and/or positioning features or the like. Such activation can also be triggered by pre-programmed events, such as the user, or device being carried by the user, leaving a certain area, or entering a certain area, or the like.

Specifically, the device can be programmed such that a ping from the monitor system activates, or latches on/off, a speaker for broadcasting a message sent to or stored on the device, and/or the device can be programmed such that a ping from the monitor system activates, or latches on/off, a microphone for capturing sound at the device which is then transmitted to the monitor system and/or a different authorized location. As set forth above, the ping can also be used to activate a camera feature on the device to obtain and send a signal showing images at the location of the device.

Also as set forth above, the various features of the device can be activated by a ping from the system, or by conditions to which the device is exposed, or on instruction from an authorized user, as several examples.

Through GPS and/or cell triangulation for zone coverage, messages such as text, auto or other types of alerts can be generated and transmitted to an authorized person when the device enters or leaves a defined zone.

The device is preferably mounted within a case which is water resistant and/or water proof, such that environmental conditions do not interfere with the critical function provided by same.

The device is advantageously programmable from one or more of different locations. Depending upon the device and intended user of same, it may be desirable to provide over the air programming for the device, and/or programming of the device utilizing soft keys on same. For example, programmable features may be desirably limited if the device is to be used by a child. In other circumstances, when the user is an adult, on-device programming may be desirable.

A monitoring feature is advantageously carried out, preferably by a dedicated system for receiving input from various devices in use by individuals. This monitoring station can advantageously record last known location, date and time of the device, a panic record and the like.

The device can further advantageously incorporate functionality including functions such as an MP3 player, or memory stick, or the like through a network, or such as a camera device, XM radio receiver or the like. Also, the transmission rate of camera and like devices can be controlled by the monitor system or other system control, and can be adapted to transmit more frequently or less frequently under given circumstances including available band width, seriousness of current conditions and the like.

Further advantageous device features are as described in the appendix attached hereto, which further describes the device, system and methods of the invention and which is incorporated herein.

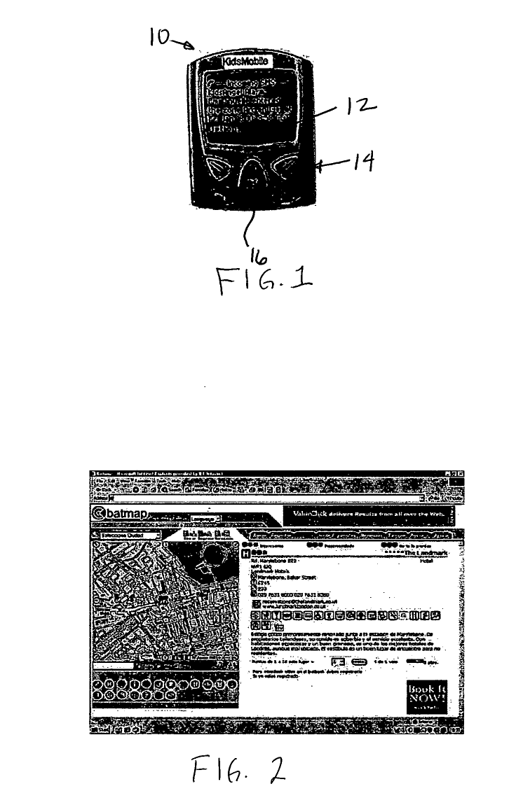

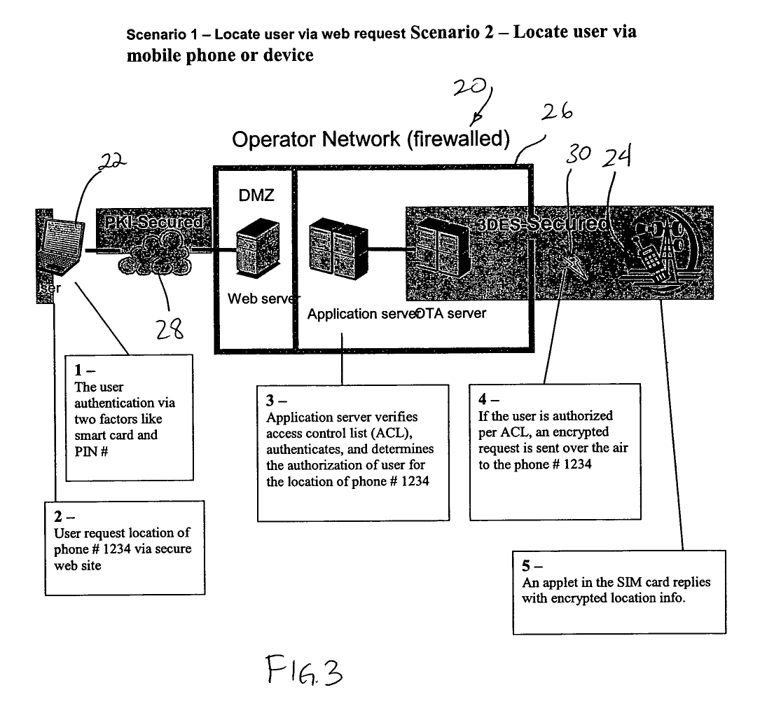

FIG. 2 illustrates a typical informational screen which could be accessed from a workstation by an authorized user to determine location of the monitored device as desired. Such a map display is particularly advantageous in that position of the monitored device, displayed on the map, can lead the authorized user or other law enforcement, emergency or other personnel quickly to a location of importance to provide assistance as necessary.

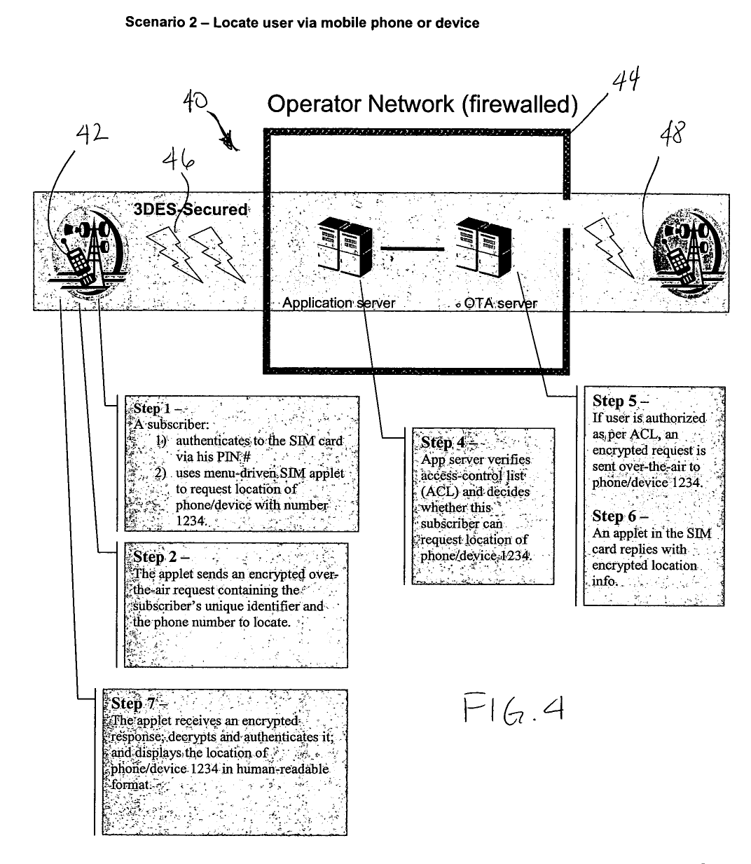

FIG. 3 schematically illustrates an operator network 20 in accordance with the present invention.

In FIG. 3, a user workstation 22 is illustrated which corresponds to an authenticated user who will use operator network 20 in accordance with the present invention to monitor location of a device 24 as desired. The workstation 22 is communicated with the support network 26, for example through public-key infrastructure (PKI)-secured communications 28, and support network 26 is advantageously communicated with device 24, for example through 3DES-secured communications 30.

Public-key infrastructure (PKI) is a combination of software, encryption technologies, and services that enables protection of the security of communications and business transactions on the Internet. PKIs can be used to integrate digital certificates, public-key cryptography, and certificate authorities into a total, enterprise-wide network security architecture. A typical PKI encompasses the issuance of digital certificates to individual users and servers; end-user enrollment software; integration with corporate certificate directories; tools for managing, renewing, and revoking certificates; and related services and support.

Triple or 3DES is another mode of digital encryption software (DES) operation. This system takes three 64-bit keys, for an overall key length of 192 bits. In an encryptor application, an entire 192-bit (24 character) key is entered, rather than entering each of the three keys individually. The Triple DES DLL then breaks the user provided key into three subkeys, padding the keys if necessary so they are each 64 bits long. The procedure for encryption is exactly the same as regular DES, but it is repeated three times. Hence the name Triple DES. The data is encrypted with the first key, decrypted with the second key, and finally encrypted again with the third key.

Consequently, Triple DES runs three times slower than standard DES, but is much more secure if used properly. The procedure for decrypting something is the same as the procedure for encryption, except it is executed in reverse. Like DES, data is encrypted and decrypted in 64-bit chunks. Unfortunately, there are some weak keys that one should be aware of: if all three keys, the first and second keys, or the second and third keys are the same, then the encryption procedure is essentially the same as standard DES. This situation is to be avoided because it results in the slow speed of triple DES with the regular security of regular DES.

Note that although the input key for DES is 64 bits long, the actual key used by DES is only 56 bits in length. The least significant (right-most) bit in each byte is a parity bit, and should be set so that there are always an odd number of 1s in every byte. These parity bits are ignored, so only the seven most significant bits of each byte are used, resulting in a key length of 56 bits. This means that the effective key strength for Triple DES is actually 168 bits because each of the three keys contains 8 parity bits that are not used during the encryption process.

The above are two preferred examples of encryption and security which can be used in accordance with the present invention. Of course, other techniques, software, routines and the like can be used as would be known to a person of ordinary skill in the art, well within the broad scope of the present invention.

User workstation 22 can advantageously be authenticated through two factors, for example through a smart card and pin number. Through workstation 22, the user can request location of device 24 through the secure connection to network 26.

At support network 26, the application server is advantageously adapted to verify that the person attempting to access the system is on an access control list, and the server further authenticates and determines the authorization of the user, for example the location of the phone making the inquiry. If the user is authorized, an encrypted request is sent from server network 26 to device 24, and device 24 replies with encrypted location information which may be provided by an applet in the SIM card of the device, for example. In this manner, secure inquiry can be made from workstation 22 as to the location or other information related to device 24, through server network 26, as desired.

Turning to FIG. 4, a further operator network 40 is illustrated wherein a subscriber using a device 42 can access a server network 44 through 3DES-secured communication link 46. During such an inquiry, the subscriber using device 42 is given an opportunity to authenticate to a particular SIM card using a PIN. Using a menu-driven SIM applet, the location of a particular device, for example phone/device number 1234 (shown in the drawing as reference numeral 48) can be made. The applet within device 42 sends an encrypted over-the-air request to server 44 containing the subscriber's unique identifier and the phone number to locate.

The application server verifies the incoming call from the access-controlled list (ACL), and decides whether this subscriber has the authority to request location of phone/device 1234.

If the device 42 is authorized as per ACL, an encrypted request is sent over the air to phone/device 1234 (reference numeral 48), and an applet in the SIM card of device 48 replies with encrypted location information. This information is received by server 44 and forwarded through an encrypted response to the applet of device 42 which decrypts and authenticates the information. Such decrypted and authenticated information is then displayed at device 42, for example in the form of the location of phone/device 1234 (reference numeral 48) as desired.

It should of course be appreciated that the combination of functionality incorporated into a single device so as to provide direct connect voice communication along with GPS and cell triangulation location determination is advantageous and a novel combination of functionality.

Additional functionality to be incorporated into the device can include a set up for monitoring of hot zones or zones of comfort for the devices, coupled with alerts to be sent to authorize devices or users based upon movement from or into such zones. Thus, for example, the monitoring system can be programmed with no entry and/or no leave zones, and can issue an alert when the device enters a no entry zone or leaves a no leave zone.

Server based monitoring of the devices can be utilized at any time for the purpose of sending the address to the authenticated and authorized devices and users, and such information can be displayed on cell phones and the like.

Communication between the servers and the device can be voice authenticated, as can communication between the server and an authorized monitor device, and calls attempting to access information can advantageously be dropped if not authorized or authenticated.

Other authentication methods which can advantageously be used in accordance with the present invention include secret passwords, voice biometrics, fingerprint biometrics, one time passwords which can be rotated, smart cards and the like, and combinations thereof. Of course, other types of authentication can also be utilized.

The monitor-authorized user can advantageously configure the system to provide desired monitoring characteristics through web based application, if desired, or through other methods.

Medical databases can also advantageously be rendered accessible through the device by authorized users and devices, whereby medical attention can readily be provided to the carrier of the device if necessary.

The server aspect of the system of the present invention can advantageously include call centers for dispatching location, medical information and the like to law enforcement, medical and rescue personnel. Further, the server or monitoring system of the present invention can advantageously be adapted to pre-fetch emergency-related information related to the location of the device upon initiation of an emergency protocol. This can advantageously save potentially critical time in dispatching appropriate local help to the location of the device user.

Particularly advantageous features of the present invention include the ping to toggle for activation aspect, which is particularly useful in connection with activation of the voice communication functionality and camera functionality of the device. This activation allows for passive monitoring of the condition of the individual carrying the device, which can be useful in a wide variety of circumstances.

It is also to be appreciated that the combination of GPS and cell triangulation incorporated into the device allows for full location coverage, indoors and outdoors, which is quite desirable for the device in accordance with the present invention.

Further, the device of the present invention can advantageously be adapted to use GPS location sensing, which is a high power drain function, only when needed while using cell triangulation when possible. In this way, battery life can be extended.

It should also be appreciated that a particular authorized user can be allowed to configure an authorized request to check location of multiple monitored devices, for example for 2 or more children. Also, multiple devices can themselves be communicated, either directly or through the server, to allow inter-device communication, play of games and the like.

It is also advantageous to have the monitoring system be adapted to check battery power on a device at given intervals, and to send an alert to a user or other authorized person that the battery should be changed. This can be coupled with commands sent to the device to operate in a power consuming mode until the battery can be replaced.

A further advantage of the present invention is to configure the device to automatically obtain updates to relevant software, and at the same time to save a fall back configuration corresponding to the last confirmed “good operation” condition. This can help to maintain operation of the device despite potential flaws in older programming or the like, with minimal risk of failure of the device due to the saved fall back configuration.

A transaction flag can advantageously be incorporated into data records or the like for use in identifying billing events, for reporting to a real-time analysis capability, and/or for log reporting.

Various components are referred to herein as being adapted to perform a particular function. In all cases, this is accomplished using known hardware, software and/or programming, all of which would be known and readily available to a person of ordinary skill in the art.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope.

What is claimed is:

1. A secure communication and locating system, comprising:
a mobile communication device adapted to communicate with a global positioning system and a cell triangulation system;
a monitoring system communicated with the mobile communication device and adapted for:
determining authorization of a user;
determining location of the mobile communication device; and
providing location to a user determined to be authorized.

2. The system of claim 1, wherein the monitoring system is adapted to determine location of the mobile communication device using both the cell triangulation system and the global positioning system.

3. The system of claim 1, wherein the monitoring system is adapted to determine location of the mobile communication device using first the cell triangulation system and then the global positioning system.

4. The system of claim 1, wherein the monitoring system communicates the mobile communication device with a user determined to be authorized.

5. The system of claim 4, wherein the monitoring system is adapted to determine authorization of the user with at least one method selected from the group consisting of selected digital codes, biometric information and combinations thereof.

6. The system of claim 1, wherein the monitoring system has stored thereon an access-controlled list of authorized users, and wherein the determining function comprises determining whether an attempted user is on the access-controlled list.

7. The system of claim 1, wherein the monitoring system is further adapted to determine if position of the mobile communication device can be sufficiently determined using the cell triangulation system, and when location cannot be sufficiently determined, to operate the mobile communication device to allow communication with the global positioning system.

8. The system of claim 1, wherein the mobile communication device is adapted for wearing by a user as a pendant or a wristwatch.

9. The system of claim 1, wherein the mobile communication device includes an interface to allow function selection by a user of the device.

10. The system of claim 9, wherein the interface includes a direct talk button and an emergency button for triggering an emergency protocol.

11. The system of claim 1, wherein the mobile communication device has a plurality of modes of operation, and wherein the monitoring system is adapted to operate the mobile communication device in a selected mode of the modes of operation.

12. The system of claim 1, wherein the mobile communication device includes a camera.

13. The system of claim 12, wherein the monitoring system is adapted to control the camera.

14. The system of claim 1, wherein the monitoring system is further adapted to record location, date, time, and panic function use information related to the mobile communication device.

15. The system of claim 1, wherein the authorization of a user is determined using a smart card and pin number.

16. The system of claim 1, wherein the monitoring system is programmed with at least one of no entry zones and no leave zones, and wherein the monitoring system is adapted to send an alert when the mobile communication device enters a no entry zone or leaves a no leave zone.

17. The system of claim 1, wherein the monitoring system is further communicated with medical databases.

18. The system of claim 1, wherein the monitoring system is further adapted to initiate a ping to the device for latching on/off a microphone of the device.

19. The system of claim 1, wherein the monitoring system is further adapted to initiate a ping to the device for latching on/off a speaker of the device.

20. The system of claim 1, wherein the monitoring system is further adapted to initiate a ping to the device for latching on/off a camera of the device.

21. The system of claim 20, wherein the monitoring system is further adapted to control a camera rate of transmit.

22. The system of claim 20, wherein the ping is initiated by at least one event selected from the group consisting of a poll on demand, a trigger by a timer, motion detection, sound detection, event detection and combinations thereof.

23. The system of claim 1, wherein the monitoring system is further adapted to allow a push to talk capability through public switch telephone network.

24. The system of claim 1, wherein the monitoring system is further adapted to allow push to talk capability through voice over internet protocol telephone network.

25. The system of claim 1, wherein the monitoring system is further adapted to pre-fetch emergency information related to the location of the device.

26. The system of claim 1, wherein the monitoring system has stored thereon medical information regarding the user of the device.

27. The system of claim 1, wherein the monitoring system is further adapted to allow multiple device monitoring.

28. The system of claim 1, wherein the monitoring system is further adapted to store location history of the device over a given time period, and to allow access to such location history to authorized users.

29. The system of claim 1, wherein the device is adapted to sense medical condition of a user of the device.

30. The system of claim 29, wherein the device has sensors of at least one of heart rate, blood pressure, and combinations thereof.

31. The system of claim 1, wherein the monitoring system is further adapted to take action upon an event threshold being out of parameter.

32. The system of claim 1, wherein the monitoring system is further adapted flutter a call transmitter and or GPS identification in the event of an emergency with no conventional signal for communicating the device with the monitoring system.

33. The system of claim 1, wherein the monitoring system is further adapted to check battery power on the device, and to issue a low battery alert when low battery power is detected.

34. The system of claim 1, wherein the monitoring system is further adapted for recording conversation between authorized users and users of the device.

35. The system of claim 34, wherein the monitoring system is further adapted to store date and time stamps of geographic locations the conversations.

36. The system of claim 1, wherein the device is adapted to emit alert sounds or messages.

37. The system of claim 1, wherein the monitoring system is further adapted to allow instant messaging to the device.

38. The system of claim 1, wherein the monitoring system is further adapted to issue alerts if users of devices are in proximity of one another.

39. The system of claim 1, wherein the monitoring system is further adapted to provide at least one of visual and audible instructions for navigation to a particular location.

40. The system of claim 1, wherein the monitoring system is further adapted to provide game play over a network and device to device.

41. The system of claim 1, wherein the monitoring system is further adapted to automatically obtain and implement updates for programming.

42. The system of claim 41, wherein the system is further adapted to save a previous good operation configuration.

43. The system of claim 1, wherein the monitoring system is further adapted to selectively operate the device in low power consumption modes.

44. The system of claim 43, wherein the low power consumption modes include turned off display and use of electronic paper.

45. The system of claim 1, wherein the device includes sensors which extend to a back of the device, or which is incorporated into a band for the device, so that monitoring of biometric information and attachment of the device to the user are allowed.

46. The system of claim 1, wherein the monitoring system is further adapted to supply user location and user data to emergency personnel.

47. The system of claim 1, wherein the monitoring system is further adapted to incorporate transaction flags in data records, and to use the transaction flags for billing and for log reporting and real-time analysis.
